(19) United States
(12) Patent Application Publication
(10) Pub. No.: US 2008/0268103 A1
(43) Pub. Date: Oct. 30, 2008

(54) Packaged consumer food products and method of communicating a company's products' health values

(75) Inventors: Myralda Maria Jacoba Derks, Cliffside Park, NJ (US); Douglas Ashley Balentine, Harriman, NY (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a UNILEVER

(21) Appl. No.: 11/823,542

(22) Filed: Jun. 27, 2007

Related U.S. Application Data
(60) Provisional application No. 60/914,814, filed on Apr. 30, 2007.

(51) Int. Cl. A23L 1/00; G06Q 30/00

(52) U.S. Cl. 426/87; 705/14

(57) ABSTRACT

A consumable food article and a method for broadcasting the nutritional quality of a company's food products or services and making healthy choices easier for the consumer which includes: providing a logo constructed as a geometrical figure having therein indicia associated with healthy eating and nutrition; wherein the logo communicates that the healthy standard is based on dietary standards or guidelines of at least one national and/or world health or food regulatory body or on international scientific guidelines; and applying the logo to a label of a consumable food product or to point of purchase advertising materials. The article bears the logo applied to a label on a package housing a consumable food material.

### BACKGROUND OF THE INVENTION

1. Field of the Invention

The invention concerns packaged consumer food products and services and a method which communicates a company's products' health benefits and emphasizes corporate values for nutrition enhancement.

2. The Relevant Art

Marks of origin appear on essentially all packaged goods and most services. These marks are known as brands. Besides origin, brands convey a message of a product's level of performance and help consumers identify a product with its source. Very few trademarks and/or service marks deliver a message of a company's products in conjunction with the principles to which the company is dedicated. Improved methods are needed to communicate these messages.

Many consumers recognize that eating healthy plays an important role in their overall health and well being. At the same time, they admit that it is not always easy to make the right choices. Nutritional information labeled on food packaging is tedious and cumbersome to figure out and understand. The present invention is aimed at ameliorating the deficiencies of the prior art by making healthy choices easier for the consumer and by broadcasting nutritional quality of food products.

Certain diet book authors, such as Bob Greene who has appeared on the Oprah Winfrey television show, have set up systems indicating their approval of certain food products that achieve weight loss. PepsiCo's “Smart Choices Made Easy” logo appears on products such as QUAKER Oatmeal and TROPICANA Orange Juice. However, a system for helping consumers make optimally healthy food choices based on recommendations of food regulatory bodies of particular territories in the world or on international scientific guidelines would be a more objective standard for healthy food selection.

All nutrients are important to a healthy nutritious diet. U.S. Dietary Guidelines recommend a diet based on a variety of foods rich in nutrients within calorie needs to help maintain a healthy weight. However, as an example, many people consume more than the recommended daily amount of trans fats, saturated fats, sugars, sodium (salt) and cholesterol. That is why the logos according to the present invention are so important in providing ease of choice of products that are good sources of many nutrients, help meet dietary goals described by food and/or health regulatory or scientific bodies, and provide confidence that the choice is based on objective dietary and scientific guidelines.

### SUMMARY OF THE INVENTION

A method is provided for broadcasting the nutritional quality of a company's food products or services and making healthy choices easier for the consumer which includes:
providing a logo constructed as a geometrical figure, preferably a circular shape, having therein indicia associated with healthy eating and nutrition, where the logo communicates that the healthy standard is based on dietary standards or guidelines of at least one world health regulatory body or based on international scientific guidelines or on international dietary guidelines; and
applying the logo to a label or advertising material at the point of purchase of a consumable product. The geometrical shape is divided into three or more different graphics or slogan areas.

Preferably, the logo represents corporate values, the values being selected from the group consisting of advocating adding vitality to life, helping consumers with healthy choices in consumer food selection, improving the nutritional quality of a company's products, informing consumers of healthier food choices, facilitating wide adoption as based on international dietary or scientific guidelines, and combinations thereof. The logo according to the present invention may be used in combination a corporate logo or trademark or trademarks.

Also provided is a consumable food article which includes:
a package housing a consumable food material; and
a logo placed on the package or an advertising material provided at the point of purchase;
said logo or said advertising material communicating the nutritional quality of a company's food products or services and making healthy choices easier for the consumer, the logo constructed as a geometrical figure having therein indicia associated with healthy eating and nutrition; wherein the logo communicates that the healthy standard is based on dietary standards or guidelines of at least one world health or food regulatory body or on international scientific or dietary guidelines; preferably also representing corporate values of helping consumers live vital and healthy lives.

Selection of products that bear the inventive logos help reduce intake of trans fats, saturated fats, sodium (salt), sugars, and cholesterol. Preferably, the products bearing the logo meet specific criteria created by a company based on national and/or international dietary guidelines for the five key nutrients of trans fats, saturated fats, sodium (salt), sugars, and cholesterol.

### BRIEF DESCRIPTION OF THE DRAWINGS

Various features and aspects of the present invention will become more readily evident from consideration of the following drawing in which:

FIG. 1 represents a logo formed as a circle;

FIG. 2 is an exemplary embodiment of the logo of FIG. 1;

FIG. 3 is another exemplary embodiment of the logo of FIG. 1.

### DETAILED DESCRIPTION OF THE INVENTION

To ameliorate the deficiencies discussed above, as most people take only a few seconds when choosing food items, now there is described in more detail the method for communicating to consumers the health benefits of a food selection by providing a logo and method that helps health-conscious consumers make healthy food choices at a glance. The method achieves a corporate Vitality mission to offer consumers unique and new ways to look good, feel good, and get more out of life. The healthy choice is the easy choice.

The principles underlying a company's nutrition enhancement and communication program are:
To help consumers everywhere make healthier choices;
To improve consumed levels of trans fats, saturated fats, sodium, sugars, /*and optionally cholesterol;
To ensure that claims and health messages are made on products with appropriate nutritional profiles;
To stimulate product innovation to improve nutritional quality.

The logos were developed following an extensive review of the consumer behavior literature, combined with comprehensive consumer research. The findings show that a simple, front-of-pack logo is effective in helping consumers make more positive nutritional choices across a wide range of product categories, and that a simple logo works as well, or better than, more complicated systems. In addition, the support of food and nutrition professional and scientific organizations helps gain understanding and trust among consumers, as well as achieve objectivity in the system.

This method is achieved by (1) improving the nutritional quality of a company's product portfolio and (2) informing consumers and helping them make healthier food choices. The logo provides a quick way to identify foods and drinks based on dietary guidelines of worldwide health organizations, international dietary and/or scientific guidelines, and food regulatory agencies, such as the FDA. Thus, consumers have a nutritional stamp they can trust—one grounded in solid research and based on at least one regulatory body's guidelines, such as, for example, U.S. Dietary Guidelines. While not limited thereto, exemplary nutrition criteria are communicated by the logo for trans fat, saturated fat, sodium and added sugars, as set by a food company's product benchmark program based on 20 sets of dietary guidelines from worldwide health organizations. For example, preferably, the logo may be limited to those products that have less than 60 mg cholesterol per serving, to be consistent with the Food and Drug Administration guidelines.

In a first aspect of the present invention, there is provided a logo based upon a symbol preferably including one or more slogans and/or graphics as a way to help making healthier choices easier for consumers, without compromising on taste, product quality or convenience. Although not restricted to specifics, at least one of the slogans and/or graphics should represent indicia associated with healthy eating and nutrition, where the logo communicates that the healthy standard is based on dietary standards or guidelines of at least one world health regulatory body, international dietary guidelines, or international scientific guidelines for healthy eating. The slogan may represent smart eating and drinking choices, and may communicate at least one corporate value relating to delivering healthy food choices. A graphic may represent a symbol of choice. Words may be in any language and, preferably, any of the Romance languages. The alphabetic characters may be in upper or lower case, in print or script form, and in any font, as long as the words they form are recognizable. It is to be understood that more than one shape and/or color is preferably present to represent each of the symbols and/or graphics within the symbol. For instance, there can be at least 2 color schemes within the symbol, and possibly anywhere from 2 to 50.

Once the logo is formed, it can be placed on outer packaging housing a consumable food material, the total forming a consumable article. The logo may also be placed on advertising materials, such as brochures, associated with packaged products also bearing the logo. Preferably, the logo is placed on the front of the package, for quick and easy healthy choice. Use of the front-of-pack logos globally on foods and beverages that meet the benchmarks defined by a food regulatory body, national and/or international dietary guidelines, or national and/or international scientific or health organization may be part of an overall-company's Nutrition Enhancement Program. The global strategy of the United Nations' World Health Organization/Food Agricultural Organization and U.S. Dietary Guidelines has recommended limiting the intake of saturated fat, trans fat, sodium and sugar for the benefit of public health. Therefore, in one preferred embodiment, a product must meet the benchmarks for at least four and more preferably five key nutrients (saturated fat, trans fat, sodium, sugar and cholesterol) to qualify for the logo. Optionally but preferably, the logo is supported by back-panel text that provides additional product-specific nutrition information.

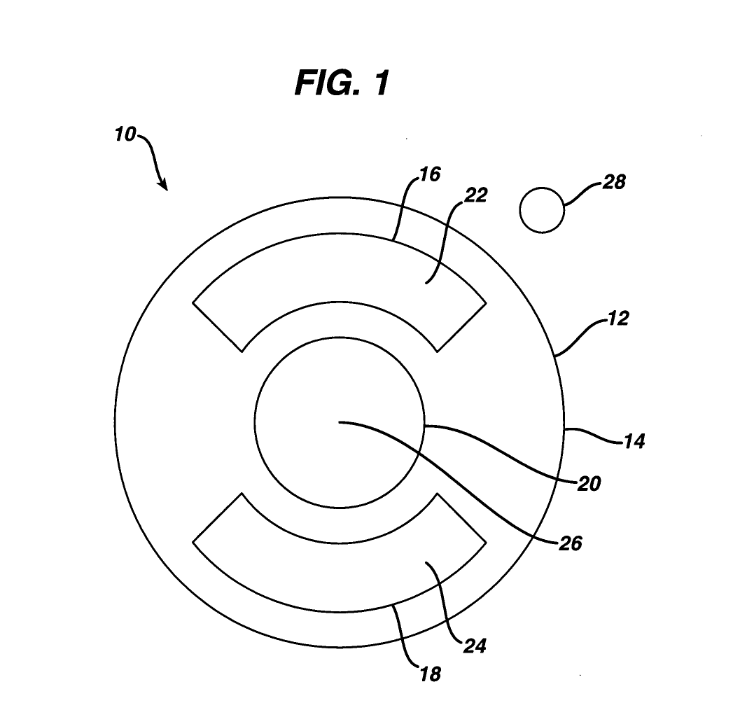

Although not limited by shape, illustrative of the present invention is FIG. 1 displaying a logo 10 formed as any shape geometrical figure or symbol 12 having a border 14, preferably a closed figure such as a circle or polygon. In this case, a circular shape is depicted, but the invention is not limited thereto. Within border 14 are formed three areas within the circle. The first area has inner top border 16, the second area has inner bottom border 18, and the third area having inner center border 20, each having any shape bordered by circular border 14 and each communicating a health message based on dietary standards or guidelines of at least one world health or food regulatory body, or based on international scientific guidelines. A first slogan 22 may be located within top border 16. A second slogan 24 may be located within bottom border 18. A graphic 26 may be located within center border 20. Each of the slogans or graphics denotes a message based on guidelines of a national or international dietary authority, such as international dietary guidelines. Additionally, as part of logo 10 there may be provided text or graphic 28 outside border 14, preferably on the top right corner, denoting a registered or unregistered trademark symbol, such as ® or ™.

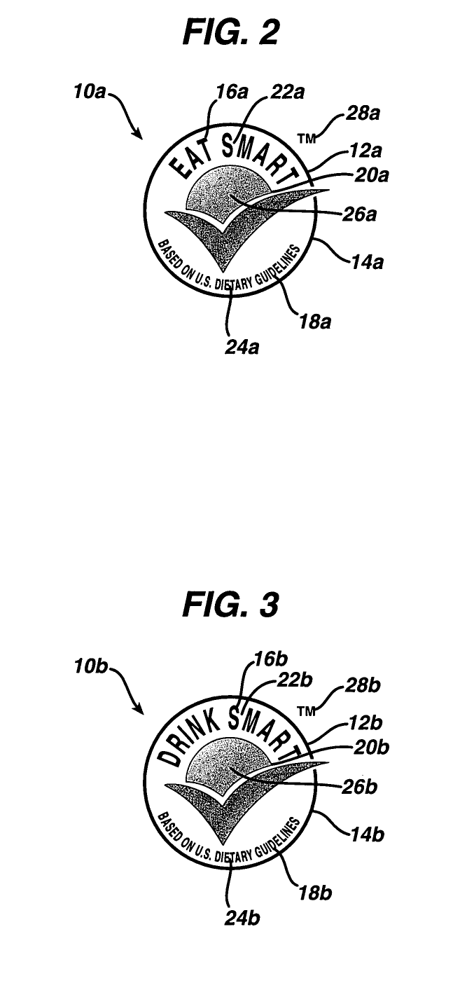

FIG. 2 is a more specific embodiment of logo 10 of the present invention, denoted as logo 10a for purpose of this example. Logo 10a formed as symbol 12a having a circular border 14a. Within border 14a are formed three areas within the circular shape. The first area has inner top border 16a, the second area has inner bottom border 18a, and the third area having inner center border 20a, each having any shape bordered by circular border 14 and each communicating a health message. A first slogan 22a may be located within top border 16a, in this case being the term “EAT SMART”. Any other slogan associated with healthy choice, such as “MY CHOICE”, “COME BIEN”, “BEBE BIEN”, or other language slogans, may be used. A second slogan 24a may be located within bottom border 18a, in this case being the term “BASED ON U.S. DIETARY GUIDELINES”. Another possible slogan would be the term “BASED ON INTERNATIONAL DIETARY GUIDELINES.” A graphic 26a may be located within center border 20a, in this case being a check mark or tick mark with rising sun symbol. Each of the slogans or graphics denotes a message based on guidelines of a government dietary guidelines authority. Additionally, as part of logo 10a there may is provided text or graphic 28a outside border 14a, preferably on the top right corner, denoting a trademark symbol ™.

FIG. 3 is another more specific embodiment of logo 10 of the present invention, denoted as logo 10b for purpose of this example. Logo 10b formed as symbol 12b having a circular border 14b. Within border 14b are formed three areas within the circle. The first area has inner top border 16b, the second area has inner bottom border 18b, and the third area having inner center border 20b, each having any shape bordered by circular border 14b and each communicating a health message. A first slogan 22b may be located within top border 16b, in this case being the term “DRINK SMART”. Any other slogan associated with healthy choice, such as “MY CHOICE”, may be used. A second slogan 24b may be located within bottom border 18b, in this case being the term “BASED ON U.S. DIETARY GUIDELINES”. Another possible slogan would be the term “BASED ON INTERNATIONAL DIETARY GUIDELINES.” A graphic 26b may be located within center border 20b, in this case being a check mark or tick mark with rising sun symbol. Each of the slogans or graphics denotes a message based on guidelines of a government dietary guidelines authority. Additionally, as part of logo 10b there may is provided text or graphic 28b outside border 14b, preferably on the top right corner, denoting a trademark symbol ™.

Another aspect of the present invention is to provide consumable articles delivering a corporate message of healthy food and/or drink choices. These articles are consumable materials which may be found in the marketplace as foods or other consumables. The products are packaged in plastic, paper or glass containers with labels affixed to the packaging. A trademark will be found on the packaging for the consumable article. In addition to the trademark, there is proposed a logo such as illustrated in FIG. 1 comprised of a shape. The area within the shape is formed of three areas representing a variety of symbols or text for healthy food products. The logo itself may also be a registered or common law trademark.

Another purpose of the communication logo is to demonstrate to consumers the corporation is not a remote holding company. It is a company dedicated to great brands that help people look good, feel good, and get more out of life. The company's goal is to help consumers make healthier choices among its products. The aim is to add vitality to life.

There is no limitation on the types of food products for which the healthy choice logo may be used, as long as the foods meet the dietary guidelines represented by the logo. Illustrative of the types of food products on which the healthy choice logo may be applied include margarine and spread foods; tomato and barbecue sauces and salad dressing food; spoonable foods such as mayonnaise and yoghurt; ready-to-eat meals and soups; spices and flavors; ice cream; tea and tea containing beverages; frozen foods; heart healthy products such as olive oil and spreads with cholesterol lowering additives. Some of the illustrative foods are those appearing under the trademarks Becel®, Rama®, Promise®, Country Crock®, I Can't Believe It's Not Butter®, Imperial® and Flora®; Ragu®, Bertolli®, Hellman's® and Wishbone®. Ready-to-eat meals and soups are available under the trademarks of Lipton® Cup-of-Soup® and Knorr®. Spices and flavors products include bouillon and spice powders which are available under trademarks such as Knorr® and Lawry's®.

In the following, several examples of application of the inventive system and method are described. The following is by way of example, not by way of limitation, of the principles of the invention to illustrate the best mode of carrying out the invention.

### EXAMPLES

### Example 1

The global strategy of the United Nations' World Health Organization/Food Agricultural Organization and U.S. Dietary Guidelines has recommended limiting the intake of saturated fat, trans fat, sodium and sugar for the benefit of public health. In a company's Nutrition Enhancement program, products are compared against nutritional benchmarks for these 4 key nutrients. The levels for these benchmarks are derived from a calorie-based translation of international and a range of national dietary guidelines, thereby eliciting trust in the source of the information. See the Table below.

TABLE 1
Company Product Benchmarks

| | |
|---|---|
| KEY NUTRIENTS | PRODUCT BENCHMARKS |

| | |
|---|---|
| Trans fat [% of energy] | <2 |
| Unless insignificant trans fat levels | |
| <0.2 g/100 g | |
| Saturated fat [% of energy] | <10 |
| Fat quality [saturated fat as % total fat] | ≦33 |
| Not to exceed 2 g/100 g | |
| Sodium content [mg/kcal] | <1.6 mg/calorie |
| Unless insignificant sodium levels: | |
| <100 mg/100 g | |
| Total sugars [% of energy]^{†} | <25 |
| Added sugars [g/100 g]^{††} | <7 |

^{†}Sugars include all mono- and disaccharides from all possible sources.
^{††}Added sugars include all mono- and disaccharides from sources other than fruit, vegetables and dairy.

In this example, the logo would represent healthy levels of the four to five key nutrients as based on United Nations' World Health Organization/Food Agricultural Organization and U.S. Dietary Guidelines. When applied to a package, the logo provides easy healthy choice for consumers.

These benchmarks are the foundation of a company's program to facilitate healthy food and services choices, and can be used for most product categories and applied internationally. For the energy-delivering nutrients (trans fat, saturated fat, and sugars) the dietary recommendations can be directly applied to the food as a percentage (%) of the total energy delivered by such food. Because dietary recommendations for sodium are provided in absolute daily amounts, these recommendations are converted to a level that can be applied to an individual product by using the highest national guideline (3,600 mg/day, in line with the average sodium intake of the Western diet) and adjusted to a daily intake of 2,250 calories, for a benchmark of <1.6 mg sodium per calorie.

A logo based on the principles outlined in this example helps busy consumers make a quick, healthy choice.

### Example 2

Another set of product category-specific benchmarks was developed to account for products where higher levels of sugars or sodium are technically essential for taste or functionality (e.g., a minimum amount of sugar is required for ice crystallization to maintain the physical characteristics of ice cream). These benchmark levels were established based on globally-available food-based standards for specific product categories. See the Table below.

TABLE 2
Company Category-Specific Benchmarks

| KEY NUTRIENTS | PRODUCT BENCHMARKS |
|---|---|
| Sodium | |
| Soups [mg/100 g] | <360 |
| Meal sauces [mg/100 g] | <540 |
| Table sauces [mg/100 g] | <1080 |
| Spreads [mg/100 g] | <720 |
| Dressings [mg/100 g] | <1080 |
| Meal replacement [mg/kcal] | <2.4 |
| Sugars | |
| Frozen desserts and ice-cream - added | <17 |
| sugars [g/100 g] | |

By applying a logo to a packaged food product or to advertising materials associated with the packaged food product, with the logo representing the product benchmarks in the Table above, a company is not only committed to improving the nutritional quality of its products, but also to providing information for consumers to help them make healthier food choices. Consumers are interested in health and nutrition will find the food labels bearing the inventive logo are not too complicated and help them make the best choice, particularly when faced with the myriad of products on the store shelf.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A method for broadcasting the nutritional quality of a company's food products or services and making healthy choices easier for the consumer, said method comprising:
providing a logo constructed as a geometrical figure having therein indicia associated with healthy eating and nutrition; wherein the logo communicates that the healthy standard is based on one selected from the group consisting of dietary standards or guidelines of at least one world health or food regulatory body, international scientific guidelines, international dietary guidelines, and a combination thereof;
wherein said standards are for five nutrients consisting of saturated fat, trans fat, sodium, sugar, and cholesterol; and
applying the logo to a label of a consumable food product or to point of purchase advertising material.

2. The method according to claim 1, wherein said geometric figure is a circle.

3. The method according to claim 1 wherein said logo represents corporate values, the values being selected from the group consisting of advocating adding vitality to life, helping consumers with healthy choices in consumer food selection, improving the nutritional quality of a company's products, informing consumers of healthier food choices, facilitating wide adoption as based on international dietary or scientific guidelines, and combinations thereof.

4. The method according to claim 1, wherein said geometric figure is divided into three or more different graphics or slogan areas.

5. The method according to claim 1, wherein said geometric figure is divided into three different graphics or slogan areas.

6. The method according to claim 5 wherein the first of the three groups has a slogan, the second of the three groups has a graphic, and the third of the three groups has a second slogan.

7. The method according to claim 5, wherein the first of the three groups comprises the slogan “EAT SMART” or “DRINK SMART” or COME BIEN” or “BEBE BIEN” or “MY CHOICE”; and the third of the three groups comprises the slogan “BASED ON U.S. DIETARY GUIDELINES” or “BASED ON INTERNATIONAL DIETARY GUIDELINES”

8. The method according to claim 5, wherein the second of the three groups comprises a graphic depicting a check mark with the rising sun.

9. The method according to claim 4, wherein said slogan is in any language.

10. A consumable food article comprising:
a package housing a consumable food material; and
a logo placed on the package or an advertising material provided at the point of purchase;
said logo or said advertising material communicating the nutritional quality of a company's food products or services and making healthy choices easier for the consumer, the logo constructed as a geometrical figure having therein indicia associated with healthy eating and nutrition; wherein the logo communicates that the healthy standard is based on dietary standards or guidelines of at least one national and/or international health or food regulatory body or on international scientific or dietary guidelines; and
wherein said standard is for five nutrients consisting of saturated fat, trans fat, sodium, sugar, and cholesterol.

11. A consumable article according to claim 10, wherein said article is a food selected from the group consisting of margarine and spread; tomato and barbecue sauces and salad dressing; spoonable foods such as mayonnaise and yoghurt; ready-to-eat meals and soups; spices and flavors; fish products; ice cream; tea and tea containing beverages; frozen foods; heart healthy products such as olive oil and spreads with cholesterol lowering additives.

12. The article according to claim 10, wherein said geometric figure is circular in shape.

13. The article according to claim 10, wherein said logo further represents corporate values of helping consumers live vital and healthy lives.

14. The article according to claim 10, comprising a slogan is in any language.

15. The article according to claim 10, further comprising a corporate logo or trademark or trademarks.

16. The method according to claim 1 further comprising providing a corporate logo or trademark or trademarks.
